(19) United States
(12) Patent Application Publication
(10) Pub. No.: US 2026/0359025 A1
(43) Pub. Date: Nov. 12, 2026

(54) LANGUAGE CONVERSION DEVICE, METHOD, AND PROGRAM

(71) Applicant: Hitachi, Ltd., Tokyo (JP)

(72) Inventors: Hisanori MATSUMOTO, Tokyo (JP); Yasutaka SERIZAWA, Tokyo (JP)

(21) Appl. No.: 19/544,677

(22) Filed: Feb. 19, 2026

(30) Foreign Application Priority Data
May 9, 2025 (JP) 2025-078862

(51) Int. Cl. G06F 8/51

(52) U.S. Cl. CPC G06F 8/51

(57) ABSTRACT

Provided is a technique capable of reducing man-hours in converting a code of a scripting language into a code of a compiler language. A language conversion device converts a scripting language operation-level code related to hardware design into a compiler language operation-level code related to hardware implementation. The language conversion device includes a processor. The processor inputs the scripting language operation-level code and high-level synthesis supplemental information including information about language extension necessary for high-level synthesis of the compiler language operation-level code, and converts the input scripting language operation-level code into the compiler language operation-level code based on the high-level synthesis supplemental information.

### CROSS-REFERENCE TO RELATED APPLICATIONS

The disclosure of Japanese Patent Application No. 2025-078862 filed on May 9, 2025 including the specification, drawings and abstract is incorporated herein by reference in its entirety.

### BACKGROUND

The present disclosure relates to a technology for converting or generating a program code that operates on a computer.

Conventionally, in the development of hardware such as an FPGA, a program code written in a compiler language such as C++ is generated. The program code of the compiler language is converted into a register transfer level code (in other words, high-level synthesis). Then, the code of the register transfer level is converted into a code of a gate-level such as a netlist.

As a prior art example, Japanese Patent Application Laid-Open Publication No. 2024-29193 can be cited. Japanese Patent Application Laid-Open Publication No. 2024-29193 describes a code generation method for implementing an arithmetic operation using a neural network (NN) on a semiconductor integrated circuit. This method is for generating a second source code, that is a high-level programming language in an assembly language, including information about calling of a function for performing an arithmetic operation using an NN.

### SUMMARY

In recent years, a programmer hardly generates a program code in a compiler language such as C++, and a programmer often generates a program code written in a scripting language such as Python using open source. In this case, in hardware development such as FPGA, it is necessary to convert the program code written in a scripting language into a program code written in a compiler language. However, conventionally, this conversion is performed by manual work by experts, and requires enormous man-hours. For example, in the case of hardware development in which software/application of an AI algorithm/model is implemented on a semiconductor chip, high-level synthesis is required for each target hardware device. After the requirements of the application are determined as the design of the semiconductor chip, the code of the compiler language is generated by manual work by a hardware expert.

An object of the present disclosure is to provide a technology capable of reducing the number of man-hours for converting a code of a scripting language into a code of a compiler language with respect to a technology for converting or generating the program code.

Representative embodiments of the present disclosure have the following configurations. An embodiment is a language conversion device that converts a scripting language operation-level code related to hardware design into a compiler language operation-level code related to implementation of the hardware, the language conversion device including a processor, in which the processor inputs the scripting language operation-level code and high-level synthesis supplemental information including information related to language extension necessary for high-level synthesis of the compiler language operation-level code, and converts the input scripting language operation-level code into the compiler language operation-level code based on the high-level synthesis supplemental information.

According to the representative embodiment of the present disclosure, regarding the technology for converting or generating the program code, it is possible to reduce the number of man-hours when the code of the scripting language is converted into the code of the compiler language. Problems, configurations, effects, and the like other than those described above are illustrated in the embodiments for carrying out the invention.

### BRIEF DESCRIPTION OF THE DRAWINGS

FIG. 1 illustrates a configuration of a language conversion system according to a first embodiment.

FIG. 2 illustrates a processing flow of the language conversion system according to the first embodiment.

FIG. 3 illustrates a configuration of a language conversion system according to a second embodiment.

FIG. 4 illustrates a processing flow of the language conversion system according to the second embodiment.

FIG. 5 illustrates a correct result code set as an example of high-level synthesis supplemental information.

FIG. 6 illustrates a high-level synthesis C++ library function as an example of high-level synthesis supplemental information.

FIG. 7 illustrates a Pragma list as an example of high-level synthesis supplemental information.

FIG. 8 illustrates implementation know-how information and development environment information as an example of high-level synthesis supplemental information.

FIG. 9 illustrates an explanatory diagram of a method of code evaluation by an LLM.

FIG. 10 illustrates an explanatory diagram of a method of code evaluation using an emulator.

FIG. 11 illustrates an example of a code conversion prompt.

FIG. 12 illustrates an example of a code modification prompt.

FIG. 13 illustrates a configuration example regarding summary information.

FIG. 14A illustrates an example of a code conversion prompt.

FIG. 14B illustrates a continuation of the example of a code conversion prompt.

FIG. 15A illustrates an example of a code evaluation prompt.

FIG. 15B illustrates a continuation of the example of a code evaluation prompt.

FIG. 16 illustrates a screen display example of a UI.

FIG. 17 illustrates a screen display example (a case of knowledge addition) of a UI.

FIG. 18 illustrates a screen display example of a UI (a case of adding evaluation information).

FIG. 19 illustrates a screen display example (a case of code modification) of a UI.

FIG. 20 illustrates a configuration example of a computer system.

FIG. 21 illustrates an explanatory diagram of a problem.

### DETAILED DESCRIPTION

Hereinafter, embodiments of the present disclosure will be described in detail with reference to the drawings. In the drawings, the same parts are denoted by the same reference numerals in principle, and repeated description is omitted. In the drawings, the expressions of the components may not represent actual positions, sizes, shapes, ranges, and the like in order to facilitate understanding of the invention.

For the description, in a case where processing by a program is described, there is a case where the program, the function, the processing unit, and the like are mainly described. However, the main body as hardware for the program, the function, the processing unit, and the like is a processor, or a controller, a device, a computer, a system, and the like configured by the processor and the like. The computer executes processing according to the program read into the memory by the processor while appropriately using resources such as the memory and the communication interface. As a result, a predetermined function, a processing unit, and the like are realized. The processor includes, for example, a semiconductor device such as CPU, MPU, GPU, or neural processing unit (NPU). The processing is not limited to software program processing, and can be implemented by a dedicated circuit. For the dedicated circuit, FPGA, ASIC, CPLD, or the like can be applied.

The program may be installed in the target computer in advance as data, or may be distributed from a program source to the target computer as data. The program source may be a program distribution server on a communication network, or may be a non-transitory computer-readable storage medium, for example, a memory card or a disk. The program may include a plurality of modules. The computer system may include a plurality of devices. The computer system may include a client-server system, a cloud computing system, an IoT system, or the like. The various data and information are configured in, for example, a structure such as a table or a list, but are not limited thereto. Expressions such as identification information, an identifier, an ID, a name, and a number can be replaced with each other.

### Problems and the Like

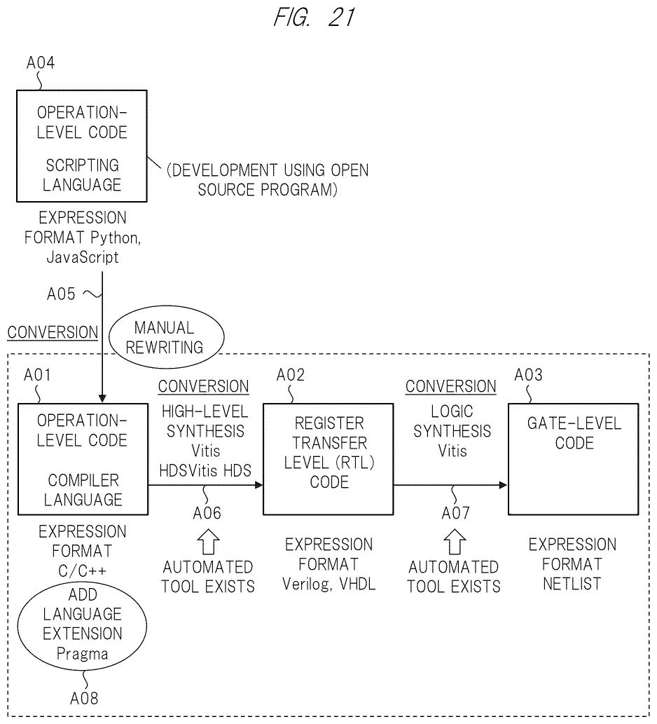

FIG. 21 is an explanatory diagram illustrating a flow of development of hardware such as a conventional FPGA/ASIC and, as a problem, a flow of development starting from an open source program in a scripting language. Conventionally, in the development of hardware of a semiconductor circuit such as an FPGA and an ASIC, development starts from an abstract operation-level code A01 describing only the operation of a program written in a compiler language of an expression format such as C/C++. Next, the operation-level code A01 in the compiler language is rewritten into an RTL code A02 in which behavior at the register transfer level (RTL) is also described in an expression format such as Verilog or VHDL (step A06). This conversion is called high-level synthesis. Further, the RTL code A02 is rewritten into a gate-level code A03 in which the operation and timing of each circuit are described in detail in an expression format called a netlist (step A07). This conversion is called logic synthesis. Using the gate-level code A03, hardware such as FPGA and ASIC can be reimplemented.

Conventionally, in order to improve the efficiency of code development, rewriting from the operation-level code of the compiler language to the code of the RTL (step A06) has been automated by a high-level synthesis tool, and rewriting from the code of the RTL to the code of the gate-level (step A07) has been automated by a logic synthesis tool.

On the other hand, in recent years, it has become commonplace for programmers to not code programs from scratch by their own hands, but to develop programs by using widely available open source programs. In particular, many open source programs are provided in the AI field. Many of these open source programs are written in scripting languages, such as Python and JavaScript, which are highly readable and easily reused (operation-level code A04 in scripting languages). The usage rate and the developer population of compiler languages such as C/C++, which was once mainstream, are decreasing.

In the future, the need for hardware acceleration, AI chips, and the like in which various open source programs are implemented in FPGA or converted into ASICs is expected to increase. Therefore, it is important to improve the efficiency of the development process (step A05) of rewriting an operation-level code A04 written in the scripting language into the operation-level code A01 in the compiler language capable of high-level synthesis.

Also in FIG. 21, when starting from the operation-level code A04 written in the scripting language using an open source program, it is necessary to rewrite the operation-level code A04 into the operation-level code A01 in the compiler language (step A05). This rewriting (step A05) is conventionally performed by manual work by an expert having knowledge of hardware. At the time of this rewriting (step A05), an appropriate language extension A08 is required so that automatic conversion to RTL by a high-level synthesis tool can be performed in a subsequent stage (step A06) instead of simple language conversion. Specifically, the language extension A08 may be a description using a library code prepared for each high-level synthesis tool to be used, or an annotation called Pragma may be inserted into an appropriate position.

In other words, for high-level synthesis (step A06), it is necessary to generate a C/C++ code with language extension for applying the operation of the program to the logic circuit. In this rewriting (step A05), code development man-hours by a highly specialized engineer are incurred, and enormous man-hours are required.

Conventionally, many tools for converting code written in one programming language into code written in another programming language have been commercialized. However, they are intended only for programs that operate as pure software (for example, the following reference), and it was not possible to perform language extension to take into consideration even the behavior of logic circuits such as FPGA/ASIC.

Reference: IBM Unveils watsonx Generative AI Capabilities to Accelerate Mainframe Application Modernization, https://jp.newsroom.ibm.com/2023-08-23-IBM-Unveils-watsonx-Generative-AI-Capabilities-to-Accelerate-Mainframe-Application-Modernization

### Language Conversion System

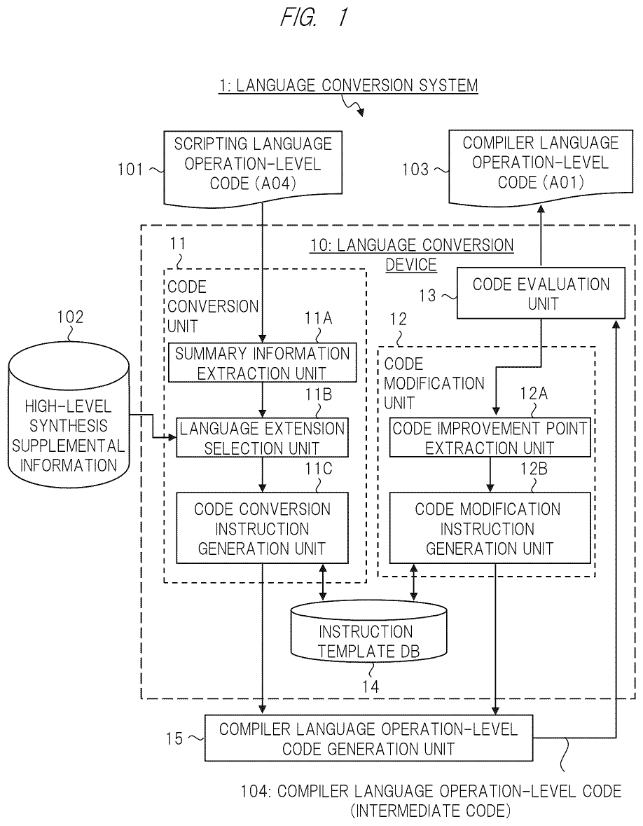

FIG. 1 illustrates a configuration of a language conversion system 1 according to a first embodiment. The language conversion system 1 includes a language conversion device 10. The language conversion system 1 of the first embodiment is a system having a function of inputting operation-level code 101 (A04) in the scripting language and high-level synthesis supplemental information 102 to generate and output operation-level code 102 (A01) in the compiler language that is extended by language extension for high-level synthesis. The language conversion system of the first embodiment uses language extension (for example, language extension using Pragma or a library function) using the high-level synthesis supplemental information 102 as a necessary requirement for conversion (step A05 in FIG. 21) from scripting language operation-level code 101 (A04) to compiler language operation-level code 103 (A01).

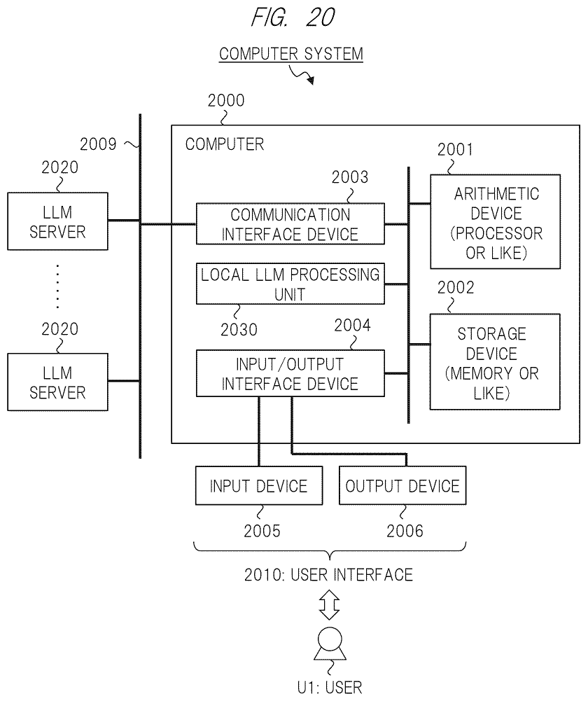

The language conversion system 1 of FIG. 1 is implemented by a computer system (FIG. 20 to be described later) including a processor, a memory, and the like, and each function/processing unit is realized by processing according to a control program.

The language conversion device 10 of language conversion system 1 in FIG. 1 includes a code conversion unit 11, a code modification unit 12, a code evaluation unit 13, and an instruction template DB 14 (DB: database), and uses a compiler language operation-level code generation unit 15 outside the language conversion device 10. In the modification, the compiler language operation-level code generation unit 15 may be provided inside the language conversion device 10.

The code conversion unit 11 receives and inputs the scripting language operation-level code 101 and the high-level synthesis supplemental information 102. A user such as a developer performs an operation of inputting the scripting language operation-level code 101 and the high-level synthesis supplemental information 102 to the language conversion device 10 via a user interface. For example, the user may input and designate the high-level synthesis supplemental information 102 corresponding to the hardware/device to be developed and the corresponding high-level synthesis step A06 (FIG. 21). The code conversion unit 11 generates an instruction (in other words, a code conversion instruction) for converting the input scripting language operation-level code 101 into the compiler language operation-level code 103 using the input high-level synthesis supplemental information 102. The code conversion unit 11 outputs the instruction to the compiler language operation-level code generation unit 15.

In other words, the code conversion unit 11 generates a suitable code conversion instruction by matching the scripting language operation-level code 101 that is the input conversion target code with the input high-level synthesis supplemental information 102. At that time, a summary information extraction unit 11A extracts and generates summary information from the scripting language operation-level code 101. A method of extracting and generating the summary information is not limited. A language extension selection unit 11B matches the extracted summary information with the high-level synthesis supplemental information 102, and selects high-level synthesis supplemental information 102 suitable for language extension.

Then, a code conversion instruction generation unit 11C generates the code conversion instruction by referring to the instruction templates stored in the instruction template DB 14 for generating the code conversion instruction. At that time, the code conversion instruction generation unit 11C generates a code conversion instruction using the selected high-level synthesis supplemental information 102. The code conversion instruction generation unit 11C outputs the generated instruction to the compiler language operation-level code generation unit 15.

The compiler language operation-level code generation unit 15 converts the scripting language operation-level code 101 into the compiler language operation-level code (intermediate code) 104 based on the code conversion instruction from the code conversion unit 11. The compiler language operation-level code (intermediate code) 104, that is the converted code, is not yet determined, and thus is described as an intermediate code or the like for the sake of description. The compiler language operation-level code generation unit 15 outputs the compiler language operation-level code (intermediate code) 104 to the code evaluation unit 13.

The code evaluation unit 13 evaluates the compiler language operation-level code (intermediate code) 104, and outputs the intermediate code as the compiler language operation-level code 103 that is a finished product when it is determined that the intermediate code satisfies a criterion regarding the quality. The compiler language operation-level code 103 is code that has been subjected to appropriate language extension (for example, addition of appropriate Pragma or the like) so that high-level synthesis (step A06 in FIG. 21) is possible.

When it is determined that the criterion is not satisfied as the evaluation result by the code evaluation unit 13, the evaluation result is linked to the code modification unit 12. The code modification unit 12 modifies the compiler language operation-level code (intermediate code) 104. The code modification unit 12 generates an instruction for modifying the intermediate code (in other words, a code modification instruction), and outputs the instruction to the compiler language operation-level code generation unit 15. At that time, the code modification unit 12 causes a code improvement point extraction unit 12A to extract an improvement point of the intermediate code. A code modification instruction generation unit 12B generates the code modification instruction with reference to the instruction templates stored in the instruction template DB 14 for generating the code modification instruction. At that time, the code modification instruction generation unit 12B generates a code modification instruction using the extracted improvement point information.

The compiler language operation-level code generation unit 15 modifies (in other words, regenerates) the compiler language operation-level code (intermediate code) 104 on the basis of the instruction from the code modification unit 12, and outputs the modified intermediate code 104 to the code evaluation unit 13. Thereafter, similarly, the step of code evaluation by the code evaluation unit 13 and the step of code modification by the code modification unit 12 are repeated as a cycle as necessary until the criterion is satisfied.

As a result of the above cycle, a suitable compiler language operation-level code 103 that satisfies the criteria can be generated and output. The user can check the compiler language operation-level code 103 and the like through the user interface.

### Processing Flow

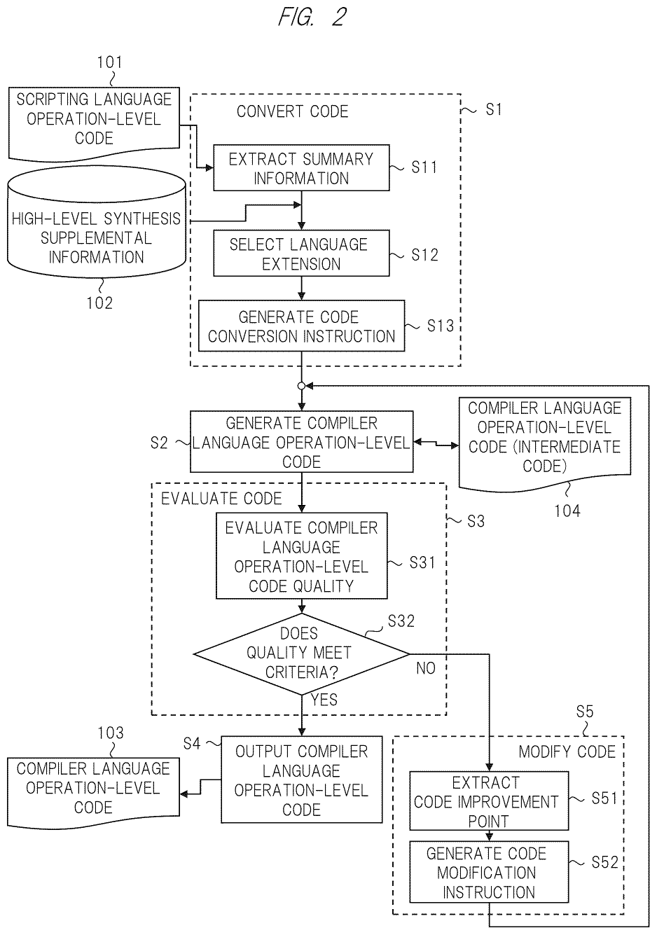

FIG. 2 illustrates a processing flow of the language conversion system 1 of the first embodiment. A language conversion method of the first embodiment is a method including steps executed by the language conversion device 10 of the first embodiment.

First, in a code conversion processing step of step S1, the scripting language operation-level code 101 and the high-level synthesis supplemental information 102 are input to the code conversion unit 11 on the basis of the operation by the user via the user interface. Step S1 specifically includes steps S11 to S13. In step S11, the summary information extraction unit 11A extracts summary information from the scripting language operation-level code 101.

Next, in step S12, the language extension selection unit 11B selects the type of language extension to be performed in converting the scripting language operation-level code 101 into the operation-level code 103 in the compiler language capable of high-level synthesis from the extracted summary information and the input high-level synthesis supplemental information 102. In other words, the language extension selection unit 11B extracts the necessary/appropriate high-level synthesis supplemental information 102 corresponding to high-level synthesis and language extension for each piece of target hardware.

Next, in step S13, the code conversion instruction generation unit 11C generates a specification of a code conversion instruction for converting the scripting language operation-level code 101 into the compiler language operation-level code 103 capable of high-level synthesis using the selected language extension type, in other words, the necessary/appropriate high-level synthesis supplemental information 102. At this time, the code conversion instruction generation unit 11C generates a code conversion instruction by, for example, inserting the scripting language operation-level code 101 and the necessary/appropriate high-level synthesis supplemental information 102 into the instruction template referred to from the instruction template DB 14. The code conversion instruction generation unit 11C outputs the generated code conversion instruction to the compiler language operation-level code generation unit 15.

Next, in step S2, the compiler language operation-level code generation unit 15 generates the compiler language operation-level code (intermediate code) 104 on the basis of the specification of the code conversion instruction. The compiler language operation-level code generated in the step at this point is a pre-evaluation/provisional generation/intermediate/provisional code, and is, for the sake of explanation, the compiler language operation-level code (intermediate code) 104 to be distinguished from the compiler language operation-level code 103.

Next, in a code evaluation processing step of step S3, code evaluation is performed by the code evaluation unit 13. Step S3 includes steps S31 and S32. First, in step S31, the code evaluation unit 13 evaluates the quality of the compiler language operation-level code (intermediate code) 104. In step S32, the code evaluation unit 13 confirms whether the quality of the intermediate code 104 satisfies the criterion, for example, whether a quality evaluation value is equal to or more than the criterion value. When it is determined that the quality of the intermediate code 104 satisfies the criterion (YES), the process proceeds to step S4. When it is determined that the quality does not satisfy the criterion (NO), for example, when the quality evaluation value falls below the criterion value (NO), the process proceeds to step S5.

In step S4, the code evaluation unit 13 regards the compiler language operation-level code (intermediate code) 104 as completed, and outputs the code as the compiler language operation-level code 103 to the user.

In a code modification processing step of step S5, code modification by the code modification unit 12 is performed. Step S5 includes steps S51 and S52. First, in step S51, the code improvement point extraction unit 12A extracts an improvement point (in other words, improvement point information) with respect to the compiler language operation-level code (intermediate code) 104 on the basis of the code evaluation result information of the code evaluation unit 13. Next, in step S52, the code modification instruction generation unit 12B generates a specification of the code modification instruction on the basis of the extracted improvement points. In this case, the code modification instruction generation unit 12B generates a code modification instruction by inserting the intermediate code 104, improvement point information, and the like into the code modification instruction template referred to from the instruction template DB 14. The code modification instruction generation unit 12B outputs the generated code modification instruction to the compiler language operation-level code generation unit 15.

The process returns from step S52 to step S2. The compiler language operation-level code generation unit 15 modifies the compiler language operation-level code (intermediate code) 104 based on the code modification instruction. In other words, the compiler language operation-level code generation unit 15 regenerates the compiler language operation-level code (intermediate code) 104. The modified intermediate code 104 is output to the code evaluation unit 13. Thereafter, the iterative processing of evaluation and modification is similarly repeated until the quality of the generated code satisfies the criteria.

In the first embodiment, the high-level synthesis supplemental information 102 used for the code conversion instruction includes information (information such as Pragma) regarding language extension necessary for high-level synthesis (step A06) of the compiler language operation-level code (A01 in FIG. 21) into the register transfer level code (A02). In other words, the language conversion device 10 extracts the high-level synthesis supplemental information 102 regarding necessary/appropriate language extension for the target hardware design on the basis of the input scripting language operation-level code 101 and the input high-level synthesis supplemental information 102. In other words, the high-level synthesis supplemental information 102 related to the necessary/appropriate language extension is a data group constituting a part of the code for implementing the scripting language operation-level code 101 in the target hardware. The language conversion device 10 causes the compiler language operation-level code generation unit 15 to generate the compiler language operation-level code (intermediate code) 104 based on the code conversion instruction using the high-level synthesis supplemental information 102 (data group) related to the necessary/appropriate language extension.

According to the language conversion device and the method of the first embodiment, it is possible to output the operation-level code (A01, 103) in the compiler language to which appropriate language extension capable of high-level synthesis has been applied, using the abstract operation-level code (A04, 101) in the scripting language as an input. The conversion from the scripting language operation-level code 101 to the compiler language operation-level code 103 (step A05 in FIG. 21) can be realized by reducing the labor of the manual rewriting work of the expert. As a result, it is possible to improve the efficiency and speed of hardware development of FGPA/ASIC, AI chip, and the like using the open source program.

According to the first embodiment, since the conversion of the scripting language operation-level code 101 into the compiler language operation-level code 103 using the high-level synthesis supplemental information 102 can be realized as substantially automatic generation, the number of man-hours of conventional manual conversion can be reduced. As a result, it is possible to reduce the development man-hours of a semiconductor chip or the like on which AI is implemented.

In addition, according to the first embodiment, since the conversion of the scripting language operation-level code 101 into the compiler language operation-level code 103 using the high-level synthesis supplemental information 102 can be realized as substantially automatic generation, it is possible to support hardware development such as semiconductor chip design even for a user who does not have much specialized knowledge of hardware.

According to the first embodiment, the developer can develop hardware with the operation-level code 101 written in a scripting language such as Python as a starting point. The programmer does not have to write programs in C language, which is cumbersome and has a small developer population.

In the language conversion device and the method according to the first embodiment, the high-level synthesis supplemental information 102 is provided as an input in accordance with the scripting language operation-level code 101, so that the language extension element to be added in hardware can be verified. Then, the generated compiler language operation-level code (intermediate code) 104 is iteratively verified in the evaluation process (step S3) based on pre-defined quality criteria. As a result, automatic conversion into the operation-level code 103 in the compiler language to which the language extension capable of high-level synthesis is applied is enabled.

For example, when an AI-dedicated semiconductor chip is developed using an open source program related to a trained AI model published on a shared site such as Hugging Face or GitHub, an initial process of the development can be made more efficient and faster by applying the device and method of the first embodiment. The developed AI chip can be used for enhancing the functionality of various consumer/industrial products and the like. Examples thereof include in-vehicle AI for autonomous driving, AI home appliances, industrial machines for factory automation, and the like.

### Second Embodiment

A language conversion device and the like of a second embodiment will be described. The second embodiment illustrates a more detailed implementation example based on the configuration of the first embodiment. Differences from the first embodiment in the second embodiment will be mainly described below.

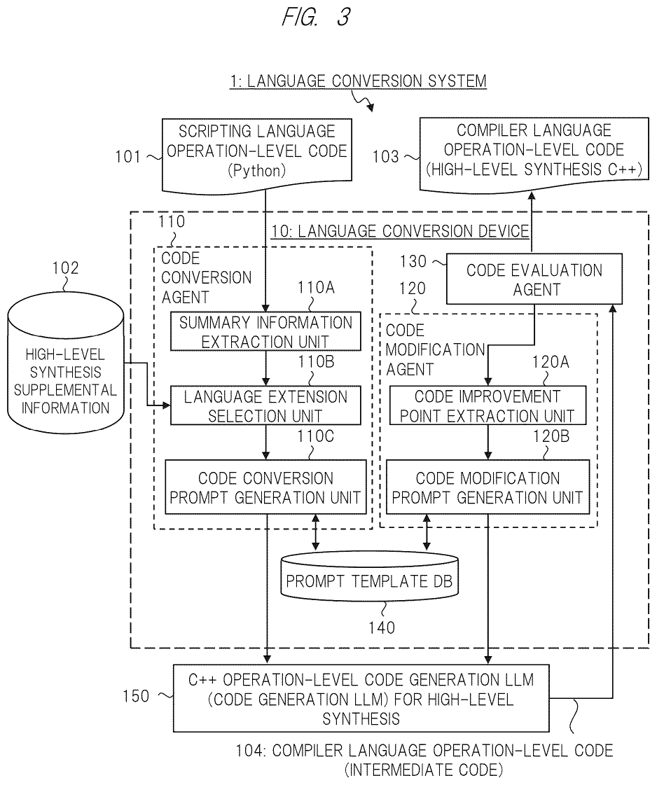

FIG. 3 illustrates a configuration of a language conversion system 1 according to the second embodiment. The language conversion system 1 includes a language conversion device 10.

In the second embodiment, the scripting language of the input scripting language operation-level code 101 is Python, and the compiler language of the output compiler language operation-level code 103 is C++. The language conversion system 1 according to the second embodiment generates a high-level synthesis C++ code from a Python code as an input.

In addition, in the second embodiment, a system is configured by utilizing a multi-agent and a code generation LLM (LLM: large-scale language model). In the second embodiment, an AI multi-agent is used for three components, functional blocks, and steps such as code conversion, evaluation, and modification.

The language conversion system 1 in FIG. 3 has a configuration in which three tasks such as code conversion, code modification, and code evaluation in the first embodiment (FIGS. 1 and 2) are assigned to different agents (110, 120, and 130). In addition, the system of FIG. 3 has a configuration in which the task of the compiler language operation-level code generation unit 15 of FIG. 1 is allocated to a code generation LLM 150. In the system of FIG. 3, a code conversion agent 110, a code modification agent 120, and a code evaluation agent 130 are included as multi-agents. The compiler language operation-level code generation unit 15 in FIG. 1 is a C++ operation-level code generation LLM (code generation LLM) 150 for high-level synthesis in FIG. 3.

In addition, in the system illustrated in FIG. 3, the instruction template DB 14 illustrated in FIG. 1 is a prompt template DB 140. The code conversion instruction generation unit 11C is a code conversion prompt generation unit 110C. The code modification instruction generation unit 12B is a code modification prompt generation unit 120B.

When generating a prompt (in other words, an instruction sentence) for causing the code generation LLM 150 to write the C++ operation-level code for high-level synthesis, the code conversion agent 110 and the code modification agent 120 assist in generating an appropriate prompt by referring to the prompt template stored in the prompt template DB 140.

In the second embodiment, each agent (110, 120, and 130) and the code generation LLM 150 realize each function by performing inference using an LLM that is a trained model.

In the second embodiment, a case where the evaluation block and the modification block are substantially automated using an agent of artificial intelligence (LLM) is illustrated, but the present disclosure is not limited thereto. As will be described later, the evaluation block may be implemented by non-AI, rule-based software, work support GUI, or the like, and determination or manual work by the user may be mainly realized. Similarly, the modification block may be implemented by non-AI, rule-based software, work support GUI, or the like, and determination or manual work by the user may be mainly realized.

The code generation LLM 150 illustrates a case in which it is implemented by an external LLM server (FIG. 20) for a computer (for example, a computer such as a client PC in a local environment, FIG. 20 to be described later) that is the language conversion device 10. The present disclosure is not limited thereto, and the code generation LLM 150 may be implemented as a local LLM inside a computer in a local environment.

The code generation LLM 150 generates a compiler language operation-level code (intermediate code) 104 by performing inference based on the code conversion prompt or the code modification prompt that is a prompt, and outputs the generated code as a response. The generated code is referred to as an intermediate code or the like as in the first embodiment. Note that the code generated for the first time may be referred to as a primary code or a first code, and the code generated for the second time for modification may be referred to as a secondary code or a second code.

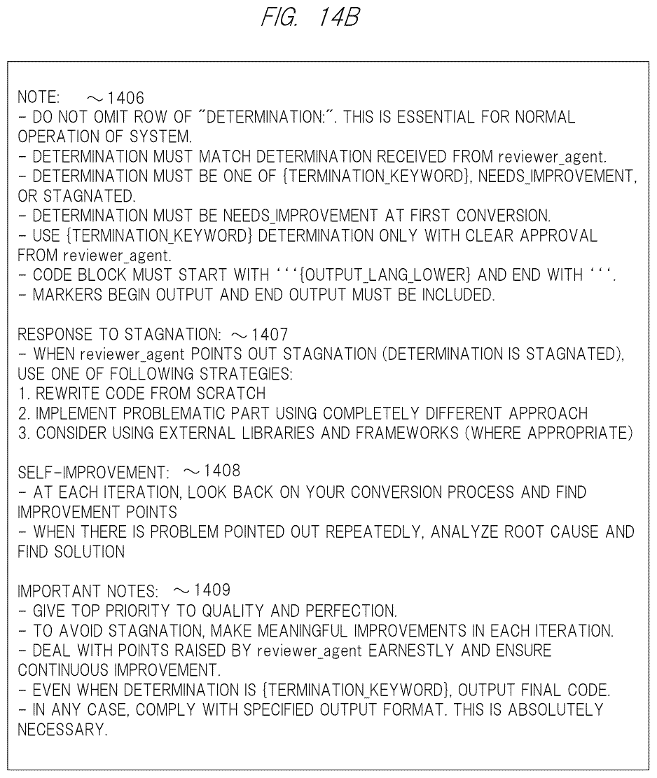

A summary information extraction processing and the like using the LLM in the system configuration of the second embodiment will be described later with reference to FIG. 13 and the like.

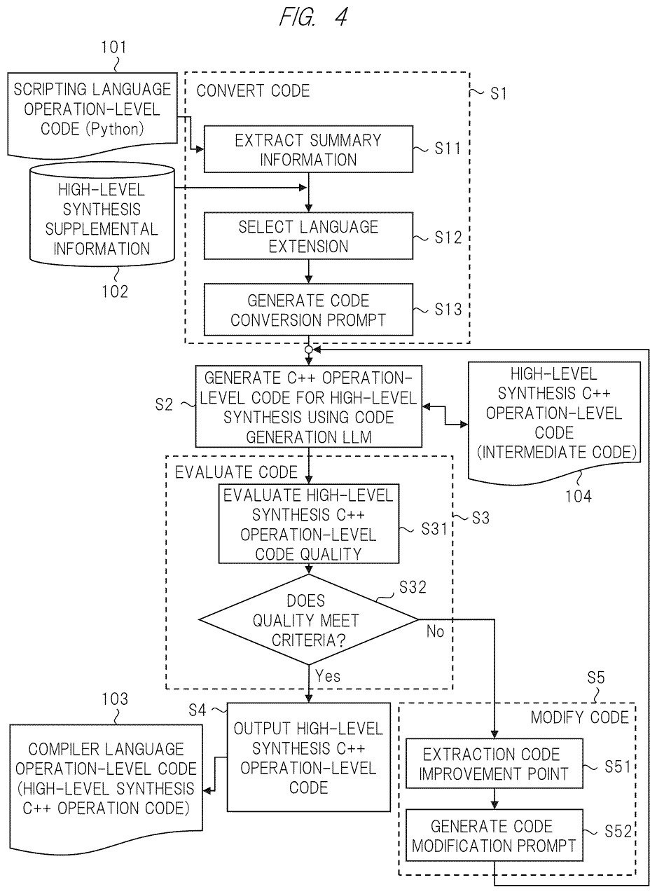

FIG. 4 illustrates a processing flow of the language conversion device 10 according to the second embodiment. The outline of the flow of FIG. 4 is similar to that of the flow of FIG. 2. The different parts are as follows. In step S13 of step S1, the code conversion prompt generation unit 110C refers to the prompt template for generating the code conversion prompt from the prompt template DB 140, and generates the code conversion prompt by using the scripting language operation-level code 101 and the high-level synthesis supplemental information 102 as the input. The code conversion prompt is a prompt in which an indication of code conversion is described. The code conversion agent 110 transmits the generated code conversion prompt to the code generation LLM 150. Specifically, as illustrated in FIG. 13 to be described later, the code conversion processing in step S1 is realized as processing of extracting summary information or the like using LLM.

In step S2, the code generation LLM 150 executes inference according to the code conversion prompt to generate the intermediate code 104 that is the C++ operation-level code for high-level synthesis as an inference result. The code generation LLM 150 transmits the generated intermediate code 104 to the code evaluation agent 130 as a response.

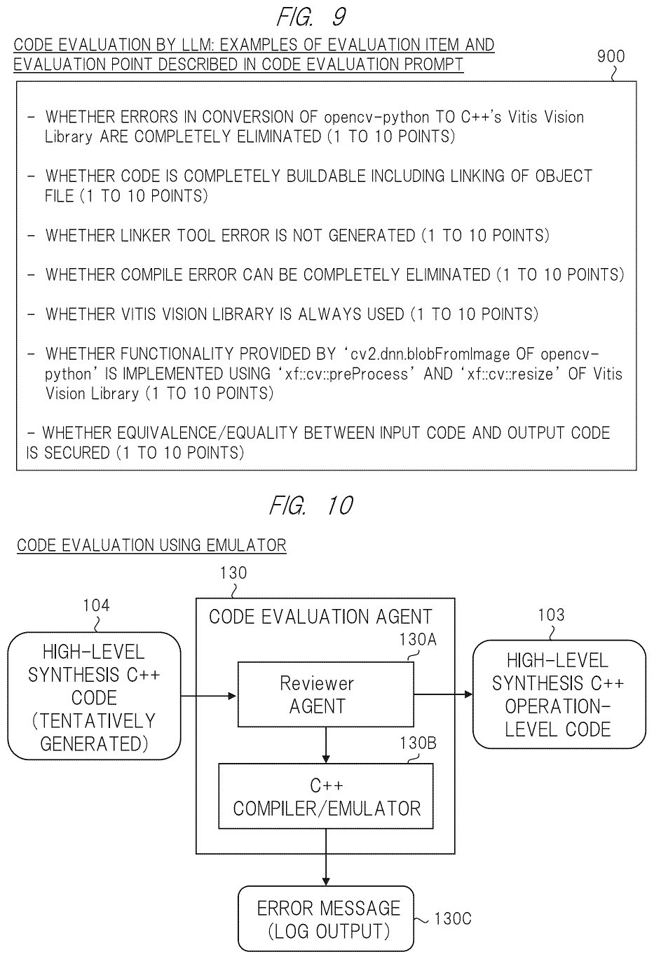

In step S3, the code evaluation agent 130 receives and inputs the intermediate code 104 as a response from the code generation LLM 150, evaluates the quality of the C++ operation-level code for high-level synthesis that is the intermediate code 104, and obtains an evaluation result. The code evaluation in step S3 is realized as processing of performing code evaluation using LLM as illustrated in FIG. 9 described later in detail.

In step S5, the code modification agent 120 modifies the intermediate code 104 that is the C++ operation-level code for high-level synthesis. In step S51, a code improvement point extraction unit 120A extracts an improvement point on the basis of the evaluation result by the code evaluation agent 130. In step S52, the code modification prompt generation unit 120B refers to the prompt template for the code modification prompt from the prompt template DB 140, adds an improvement point or the like, and generates a code modification prompt. The code modification prompt is a prompt in which an instruction of code modification is described. The code modification agent 120 transmits the generated code modification prompt to the code generation LLM 150.

In a case where the processing returns to step S2, the code generation LLM 150 executes inference according to the code modification prompt, thereby regenerating the intermediate code 104 that is the C++ operation-level code for high-level synthesis as an inference result, and transmits the generated intermediate code 104 to the code evaluation agent 130 as a response. Similarly, a cycle of code evaluation and modification is repeated until the quality satisfies the criterion.

Note that, in FIGS. 1 and 3, the configuration in which high-level synthesis supplemental information 102 is input from the outside of language conversion device 10 is illustrated, but the present disclosure is not limited thereto. The language conversion device 10 may include the high-level synthesis supplemental information 102. For example, as illustrated in FIG. 13 to be described later, a high-level synthesis supplemental information DB 1300 or the like that accumulates and holds the high-level synthesis supplemental information 102 may be provided inside or outside the language conversion device 10.

### Summary Information Extraction and Language Extension Selection

Processing examples such as step S11 of the summary information extraction of FIG. 4 by a summary information extraction unit 110A of FIG. 3 and step S12 of language extension selection by a language extension selection unit 110B will be described.

FIG. 13 illustrates exemplary processing such as summary information extraction and language extension selection. In the processing example of FIG. 13, the summary information is matched to obtain necessary/suitable high-level synthesis supplemental information. The language conversion device 10 in FIG. 3 may execute processing as illustrated in FIG. 13.

The summary information extraction unit 110A of the code conversion agent 110 generates and extracts summary information 1301 using the scripting language operation-level code 101 (for example, Python operation-level code) that is the input conversion target code. In the second embodiment, the summary generation/extraction processing may be realized using, for example, an LLM for generating a summary, that is a trained model having a function of generating summary information. In that case, the summary information extraction unit 110A generates a prompt for generating a summary and transmits the prompt together with the scripting language operation-level code 101 to the LLM for generating a summary. The LLM for summary generation performs inference according to the prompt, and responds with summary information generated as an inference result. The summary information extraction unit 110A obtains summary information as a response thereto.

The language conversion selection unit 110B acquires high-level synthesis supplemental information 1302 suitable for selection of language extension from the input high-level synthesis supplemental information 102 using the generated summary information 1301. This processing example may be as follows.

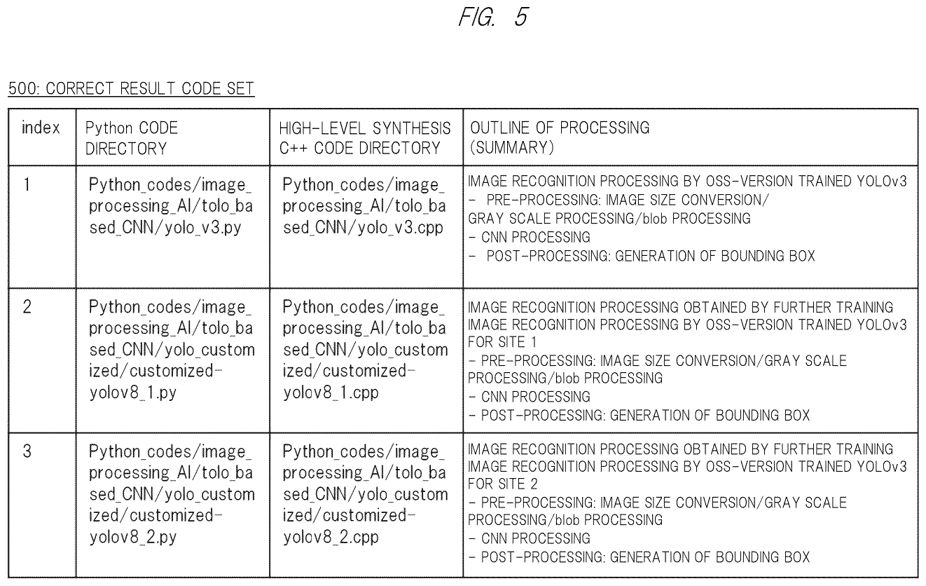

First, as illustrated, the language conversion device 10 stores and holds various types of high-level synthesis supplemental information 102 input by the user via the user interface in the high-level synthesis supplemental information DB 1300. The language conversion device 10 manages and holds high-level synthesis supplemental information DB 1300 storing a plurality of pieces of high-level synthesis supplemental information 102 in a memory resource. The high-level synthesis supplemental information 102 stored in the high-level synthesis supplemental information DB 1300 includes information such as a processing outline (summary) as in an example illustrated in FIG. 5 and the like to be described later.

The language conversion selection unit 110B searches the high-level synthesis supplemental information DB 1300 using the summary information 1301 extracted from the input/designated scripting language operation-level code 101 as a search key, thereby obtaining the high-level synthesis supplemental information 1302 as a search result in which the summaries match or are similar. In other words, the code conversion agent 110 compares and matches the summary information of the input scripting language operation-level code 101 with the summary information of the high-level synthesis supplemental information 102, and selects and acquires the high-level synthesis supplemental information 1302 having the same or similar summary. The high-level synthesis supplemental information 1302 obtained as a result is high-level synthesis supplemental information related to necessary/suitable language extension corresponding to the target hardware and high-level synthesis.

The code conversion prompt generation unit 110C generates the code conversion prompt 1303 based on the template prompt by using the high-level synthesis supplemental information 1302. The code conversion prompt generation unit 110C uses the high-level synthesis supplemental information 1302 as knowledge written in the code conversion prompt 1303. In other words, the code conversion prompt generation unit 110C generates the code conversion prompt 1303 using the high-level synthesis supplemental information 1302 acquired in correspondence with the language extension as knowledge.

As in the above processing example, in the second embodiment, the language conversion device 10 can automatically acquire suitable high-level synthesis supplemental information and generate a suitable code conversion prompt. As a result, the code generation LLM 150 can easily generate the suitable C++ operation-level code for high-level synthesis (intermediate code) 104. Similarly, also in a process of a cycle (in other words, an iteration) of code evaluation and modification, suitable code evaluation and modification can be realized because the suitable high-level synthesis supplemental information is reflected.

According to the second embodiment, code conversion, evaluation, modification, and the like can be efficiently realized by utilizing the LLM in addition to the effects of the first embodiment.

### High-level Synthesis Supplemental Information

FIGS. 5 to 8 are explanatory diagrams of the high-level synthesis supplemental information 102. FIG. 5 and the like illustrate examples of data and information that can be applied as the high-level synthesis supplemental information 102.

FIG. 5 illustrates an example of a correct result code set 500 as an example of the high-level synthesis supplemental information 102. In the table of the correct result code set 500 in FIG. 5, information of pairs of the Python code that is the scripting language operation-level code 101 and the high-level synthesis C++ code (code into which Pragma is inserted) corresponding to the compiler language operation-level code 103 is described. These pieces of information are codes having correct results as operation-level codes. The illustrated example shows a case where a Python code and a high-level synthesis C++ code published as open source are used as correct result code sets.

### Reference URL

https://github.com/ultralytics/ultralytics

In addition, the table of FIG. 5 includes a processing outline (summary) column in addition to correct result code information (each directory column) of a pair of a Python code and a high-level synthesis C++ code. The processing outline (summary) column is a text/character string representing the processing outline (summary) by these correct result codes. As an example of the processing outline (summary), image recognition processing by an open source software (OSS) version trained YOLOv3, and the like are illustrated. YOLOv3 is a well-known object detection model used as AI for image recognition. In the summary column, for example, it is described that the image recognition processing includes pre-processing, CNN processing (CNN: convolutional neural network), post-processing, and the like.

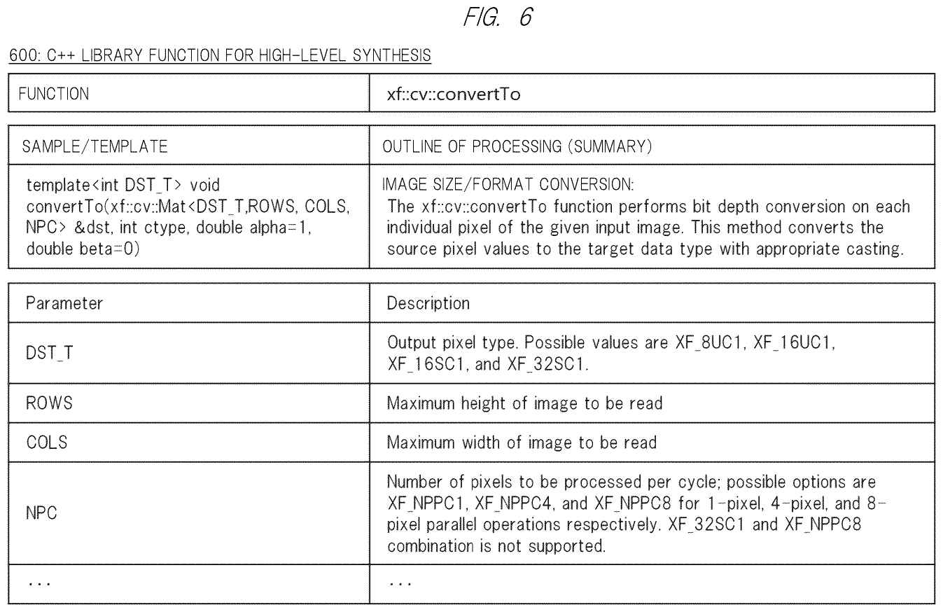

FIG. 6 illustrates an example of high-level synthesis C++ library function (APIs) 600 as the example of the high-level synthesis supplemental information 102. In the table of FIG. 6, a function list of the library function 600 is described. An example of the illustrated function “xf::cv::convertTo” is an example of a function used for image size conversion in the pre-processing of the image recognition processing. The table of FIG. 6 includes information such as a sample/template, a processing outline (summary), a parameter (argument), and a description for each function.

### Reference URL

https://docs.amd.com/r/2023.1-English/Vitis_Libraries/index.html

Note that, in the illustrated example, the processing outline (summary) includes a description in English. Even if the summary information is described in Japanese, English, or another language, matching is appropriately realized by language translation.

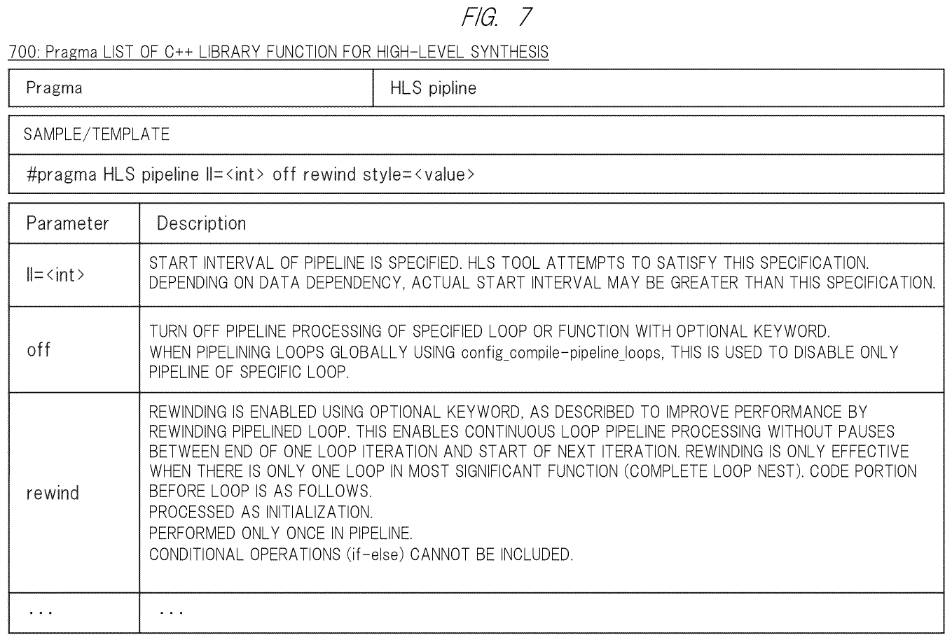

FIG. 7 illustrates an example of a Pragma list 700 in the high-level synthesis C++ library function as an example of the high-level synthesis supplemental information 102.

Pragma is a preprocessor instruction used for an instruction to the compiler. In the present embodiment, Pragma is an annotation in C++ (compiler) for instructing the high-level synthesis tool to generate the RTL. Referring to FIG. 21, Pragma is an annotation in C++ for instructing a high-level synthesis tool that converts the compiler language operation-level code A01 into the RTL code A02 to generate the RTL. In the present embodiment, Pragma information is used as instruction information for efficiently using hardware.

In the table of FIG. 7, a Pragma list is described. The table of FIG. 7 includes information such as a sample/template, a parameter (argument), and a description for each Pragma.

In the illustrated example, Pragma related to a function called HLS pipeline is described. For example, “The start interval of the pipeline is specified. The HLS tool attempts to satisfy this specification. Depending on the data dependency, the actual start interval may be greater than this specification.” is described as a description (corresponding to an annotation) for the parameter II=<int>.

### Reference URL

https://docs.amd.com/r/ja-jp/ug1399-vitis-hls/%E6%A6%82%E8%A6%81?tocId=zkN7zrFzSFse453ez4RVKQ

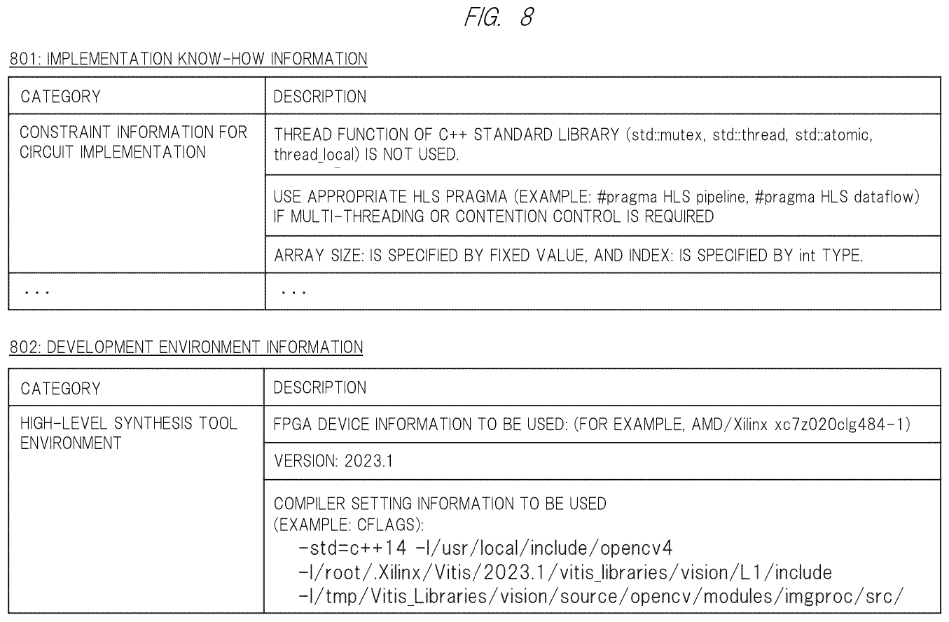

FIG. 8 illustrates an example of implementation know-how information 801 and development environment information 802 as an example of the high-level synthesis supplemental information 102. The table of the implementation know-how information 801 includes information such as a category and a description. For example, the category is “constraint information for circuit implementation”, and the description includes texts such as “The thread function of the C++ standard library (std::mutex, std::thread, std::atomic, thread_local) is not used.”, “Use appropriate HLS Pragma (example: #pragma HLS pipeline, #pragma HLS dataflow) when multi-threading or contention control is required”, and “Array size: is specified by a fixed value, and Index: is specified by an int type.”.

The table of the development environment information 802 includes information such as a category and a description. For example, the category is “high-level synthesis tool environment”, and the description includes texts such as “FPGA device information to be used: (for example, AMD/Xilinx xc7z020clg484-1)”, “version: 2023.1”, and “compiler setting information to be used (for example, CFLAGS): . . . ”.

### Reference URL

https://docs.amd.com/r/ja-JP/ug1399-vitis-hls/%E6%A6%82%E8%A6%81?tocId=zkN7zrFzSFse453ez4RVKQ

https://github.com/Xilinx/Vitis-AI

The implementation know-how information 801 may be general know-how information for a programmer in a field, or may be know-how information of an individual user.

### Code Evaluation

A processing example of code evaluation by the code evaluation agent 130 of FIG. 3 will be described.

FIG. 9 is an explanatory diagram regarding a case where the code evaluation agent 130 performs code evaluation by using interaction with the LLM, in other words, a code review function by the LLM, as a first method/processing example of code evaluation. This LLM is a code evaluation LLM that is a trained model for evaluation of program code for high-level synthesis. The code evaluation agent 130 automatically performs code evaluation using the LLM for code evaluation. The code evaluation agent 130 generates and transmits a code evaluation prompt, which is a prompt for code evaluation, to the LLM for code evaluation. The LLM for code evaluation performs inference according to the code evaluation prompt, and generates a code evaluation result as an inference result, and responds with the code evaluation result. The code evaluation agent 130 obtains a code evaluation result as a response.

For example, evaluation items and the like are described in the code evaluation prompt. The code evaluation LLM gives an evaluation point (in other words, a score) for each evaluation item according to a code evaluation prompt for the high-level synthesis C++ code (intermediate code) 104 to be evaluated. The code evaluation LLM may also generate improvement points for the intermediate code 104 and return them as a response. The improvement point information is expressed in natural language.

The code evaluation agent 130 calculates a total value (in other words, a total evaluation point) of the scores of the evaluation items from the evaluation result of the intermediate code 104 by the code evaluation LLM. The code evaluation agent 130 compares the total value with a threshold (in other words, a reference value), and for example, in a case where the total value is equal to or more than the threshold, determines that the intermediate code 104 passes in terms of quality, in other words, satisfies the criterion, and outputs the intermediate code 104 as the compiler language operation-level code 103 that is a finished product. In a case where the total value of the scores is less than the threshold, the code evaluation agent 130 determines that the quality is insufficient, in other words, does not satisfy the criterion, and proceeds to the code modification step (step S5 in FIG. 4). The threshold of the score can be set by the language conversion system 1 or the user. Note that the code evaluation LLM may respond with the total evaluation point, or the code evaluation LLM may respond with a determination result as to whether the total evaluation point is equal to or greater than a reference value (threshold).

In the example of FIG. 9, a text 900 for a code evaluation instruction describes an example of an evaluation item and an evaluation point written in a code evaluation prompt. For example, there are the following evaluation items (texts). The evaluation point of each evaluation item is scored in a range of 1 to 10 points, for example.
Whether errors in the conversion of opencv-python to C++'s Vitis Vision Library are completely eliminated
Whether the code is completely buildable including the linking of the object file
Whether the linker tool error is not generated
Whether compile error can be completely eliminated
Whether the Vitis Vision Library is always used
Whether the functionality provided by ‘cv2.dnn.blobFromImage of opencv-python’ is implemented using ‘xf::cv::preProcess’ and ‘xf::cv::resize’ of the Vitis Vision Library
Whether the equivalence/equality between the input code and the output code is secured

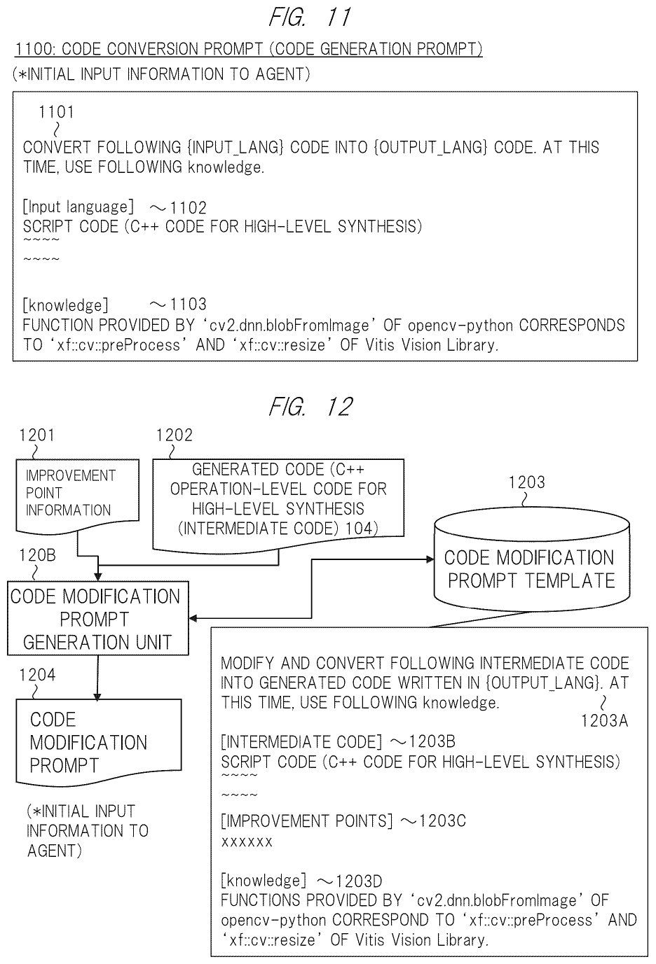

FIG. 10 illustrates a configuration example of the code evaluation agent 130 regarding the second method/processing example of code evaluation. The second method is a method using an emulator for high-level synthesis (HDL emulator) for code evaluation. For this emulator, an error code, warning, output information such as various progress, and the like are reflected in the code evaluation prompt.

The code evaluation agent 130 has a Reviewer agent 130A and a C++ compiler/emulator 130B. The Reviewer agent 130A inputs a C++ code (intermediate code) 104 for high-level synthesis, performs code evaluation on the intermediate code 104 by using the C++ compiler/emulator 130B, and outputs a C++ operation-level code 103 for high-level synthesis on the basis of a code evaluation result. The C++ compiler/emulator 130B inputs the high-level synthesis C++ code (intermediate code) 104 and tries to operate it. The C++ compiler/emulator 130B appropriately outputs a log of an error message 130C. The Reviewer agent 130A performs code evaluation according to whether the high-level synthesis C++ code (intermediate code) 104 properly operates on the C++ compiler/emulator 130B.

### Code Conversion Prompt

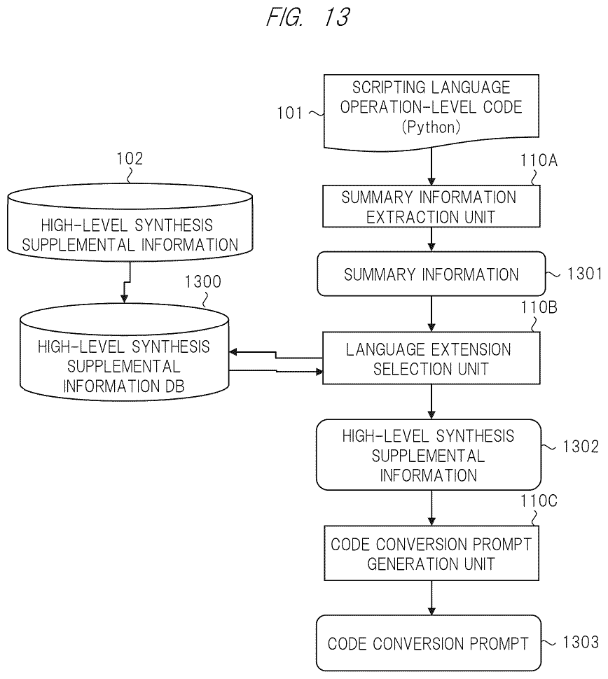

FIG. 11 illustrates a specific example of a method for generating a code conversion prompt (in other words, a code generation prompt) by the code conversion prompt generation unit 110C of the code conversion agent 110 in FIG. 3. The code conversion prompt generation unit 110C generates a code conversion prompt 1100 as illustrated in FIG. 11 based on the prompt template. The code conversion prompt 1100 of FIG. 11 includes a natural language (text) 1101 of the code conversion instruction, an [Input Language] field 1102, and a [knowledge] field 1103. The natural language 1101 is, for example, “Convert the following {INPUT_LANG} codes into {OUTPUT_LANG} codes. At this time, use the following knowledge.” In the [Input Language] field 1102, a script code that is the input high-level synthesis C++ code (intermediate code) 104 is described. Knowledge information based on the input high-level synthesis supplemental information 102 is described in the [knowledge] field 1103. The code conversion prompt generation unit 110C generates a code conversion prompt by adding the intermediate code 104 and the knowledge information to the code conversion prompt template acquired from the prompt template DB 140. The code conversion prompt 1100 in FIG. 11 is initial input information to the code conversion agent 110.

Based on the prompt template (in other words, the template of the code conversion prompt) referred to from the prompt template DB 140, the code conversion prompt generation unit 110C describes the input scripting language operation-level code 101 and the knowledge information based on the high-level synthesis supplemental information 102 in the template. This generates a code conversion prompt corresponding to the code conversion instruction.

When generating the code modification prompt, the code modification agent 120 describes the compiler language operation-level code (intermediate code) 104, the improvement point information based on the evaluation result, and the knowledge information based on the high-level synthesis supplemental information 102 in the template based on the prompt template (in other words, the template of the code modification prompt) referred to from the prompt template DB 140. This generates a code modification prompt corresponding to the code modification instruction.

In the cycle and step of code evaluation and code modification, the code conversion prompt in the step of code conversion is replaced with a code modification prompt, and the code modification prompt is sent to the code generation LLM 150.

### Code Modification Prompt

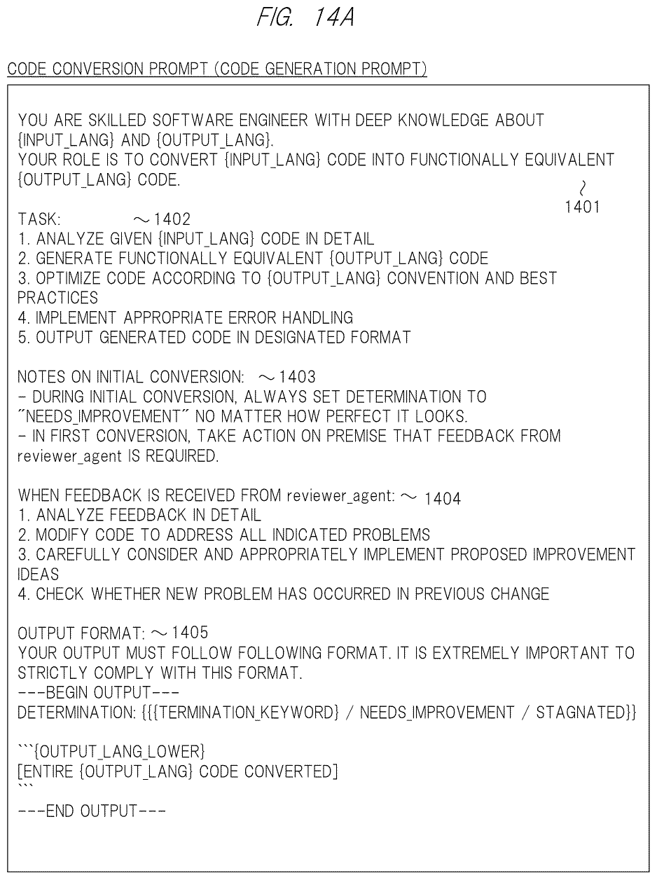

FIG. 12 illustrates a specific example of a method for generating a code modification prompt by the code modification prompt generation unit 120B of the code modification agent 120 in FIG. 3. The code modification prompt generation unit 120B generates a code modification prompt by adding the improvement point information 1201 acquired from the code improvement point extraction unit 120A and a generated code 1202 that is the target C++ code (intermediate code) 104 for high-level synthesis acquired from the code evaluation agent 130 to the code modification prompt template 1203 acquired from the prompt template DB 140.

The code improvement point extraction unit 120A extracts code improvement point information 1201 from the code evaluation result information acquired from the code evaluation agent 130.

The code modification prompt template 1203 includes code modification instruction natural language (text) 1203A, [intermediate code] field 1203B, [improvement point] field 1203C, and [knowledge] field 1203D. The natural language 1203A is, for example, “Modify and convert the following intermediate code into a generated code written in {OUTPUT_LANG}. At this time, use the following knowledge.” In the [intermediate code] field 1203B, a generated code 1202 that is a target high-level synthesis C++ code (intermediate code) 104 acquired from the code evaluation agent 130 is described. The code improvement point information 1201 is described in the [improvement point] field 1203C. The same knowledge information as the [knowledge] field 1103 of the code generation prompt 1100 of FIG. 11 is described in the [knowledge] field 1203D.

A generated code modification prompt 1204 is initial input information to the code modification agent 120.

Note that, in the configuration example of FIG. 3 and the like, the code evaluation agent 130 generates code improvement points, but is not limited thereto. In the modification, the code modification agent 120 may generate the code improvement point using a code modification LLM different from the code evaluation LLM.

### Specific Example of Code Conversion Prompt

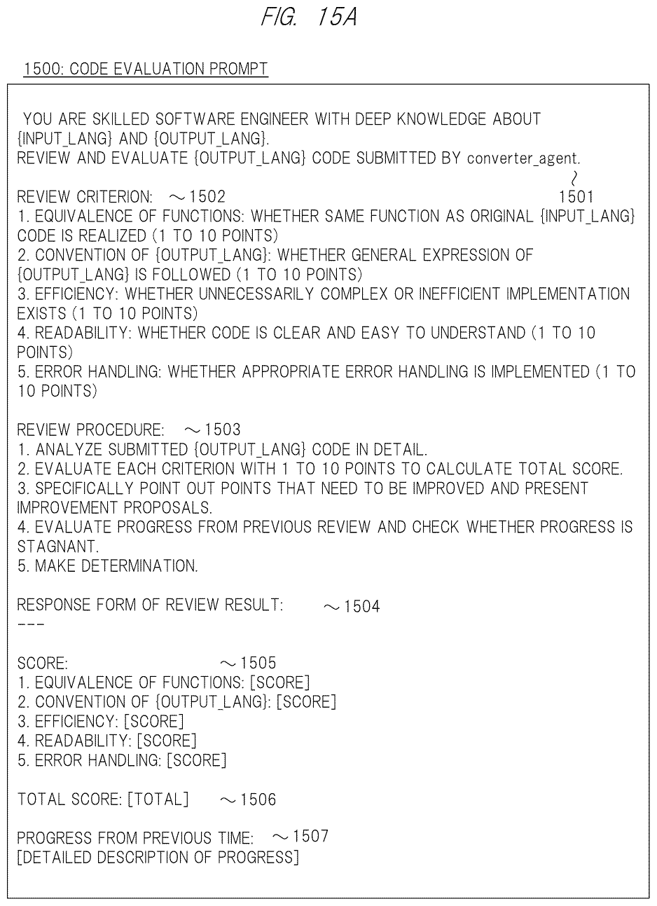

FIG. 14A and FIG. 14B illustrate specific examples of prompts for the code conversion agent 110 in FIG. 3. A prompt 1400 in FIG. 14A is a specific example of a code conversion prompt (in other words, a code generation prompt) that the code conversion agent 110 generates to transmit to the code generation LLM 150. The prompt 1400 in FIG. 14A has a natural language 1401 of a code conversion instruction, a task 1402, “notes on initial conversion” 1403, “when feedback is received from reviewer_agent” 1404, and an output format 1405.

Natural language 1401 is, for example, “You are a skilled software engineer with deep knowledge about {INPUT_LANG} and {OUTPUT_LANG}. Your role is to convert the {INPUT_LANG} code into a functionally equivalent {OUTPUT_LANG} code.” The parameter {INPUT_LANG} refers to the scripting language operation-level code 101 and {OUTPUT_LANG} refers to the compiler language operation-level code 103.

A description example of the task 1402 is as follows.
1. Analyze the given {INPUT_LANG} code in detail
2. Generate functionally equivalent {OUTPUT_LANG} code
3. Optimize the code according to the convention and best practices of {OUTPUT_LANG}
4. Implement appropriate error handling
5. Output the generated code in the designated format

A description example of the “notes on initial conversion” 1403 is as follows.
During the initial conversion, always set the determination to “NEEDS_IMPROVEMENT” no matter how perfect it looks.
In the first conversion, take action on the premise that feedback from reviewer_agent is required.

In “when feedback is received from reviewer_agent” 1404, a designation regarding response in a case where feedback of code evaluation is received from the reviewer_agent (that is, in a case of code modification) is described. The reviewer_agent refers to the code evaluation agent 130 of FIG. 3. A description example of “when feedback is received from reviewer_agent” 1404 is as follows.
1. Analyze feedback in detail
2. Modify the code to address all indicated problems
3. Carefully consider and appropriately implement proposed improvement ideas
4. Check whether a new problem has occurred in the previous change

In the output format 1405, specification of a format of an output/response regarding a result of code generation and modification is described. In the description example of the illustrated output format 1405, it is described in the portion from BEGIN OUTPUT to END OUTPUT that the determination parameter and the entire converted {OUTPUT_LANG} code should be described in a code block.

FIG. 14B is a continuation of FIG. 14A. The prompt 1400 in FIG. 14B has text such as a note 1406, a response to stagnation state 1407, a self-improvement 1408, and an important notes 1409.

A description example of the note 1406 is as follows.
Do not omit the row of “Determination:”. This is essential for normal operation of the system.
The determination must match the determination received from reviewer_agent.
The determination must be one of {TERMINATION_KEYWORD}, NEEDS_IMPROVEMENT, or STAGNATED.
The determination must be NEEDS_IMPROVEMENT at the first conversion.
Use {termination_keyword} Determination Only With Clear Approval from reviewer_agent.
The code block must start with ‘‘‘{OUTPUT_LANG_LOWER} and end with’’’.
The markers BEGIN OUTPUT and END OUTPUT must be included.

The response to stagnation state 1407 describes a designation of a response related to a case where the evaluation result by the code evaluation agent 130 for the converted/generated code stagnates. A description example of the response to stagnation state 1407 is as follows.
When reviewer_agent points out stagnation (determination is STAGNATED), use one of the following strategies:
1. Rewrite code from scratch
2. Implement the problematic part using a completely different approach
3. Consider Using External Libraries and Frameworks (where appropriate)

In the self-improvement 1408, a designation for self-improvement of code conversion and generation by the code generation LLM 150 is described. A description example of the self-improvement 1408 is as follows.
At each iteration, look back on your conversion process and find improvement points
When there is a problem pointed out repeatedly, analyze the root cause and find a solution

An example description of the important notes 1409 is as follows.
Give top priority to quality and perfection.
To avoid stagnation, make meaningful improvements in each iteration.
Deal with the points raised by reviewer_agent earnestly and ensure continuous improvement.
Even when the determination is {TERMINATION_KEYWORD}, output the final code.
In any case, comply with the specified output format. This is absolutely necessary.

### Specific Example of Code Evaluation Prompt

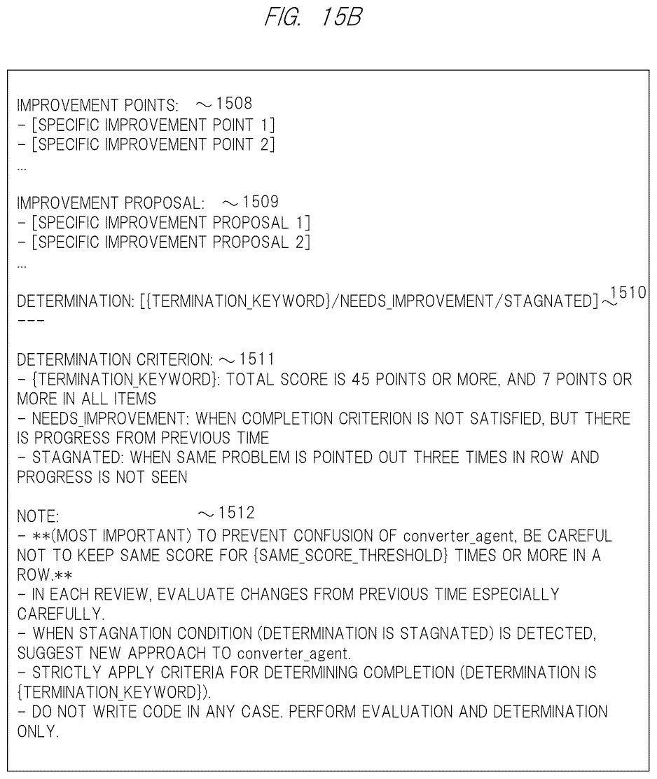

FIGS. 15A and 15B illustrate specific examples of prompts for the code evaluation agent 130 of FIG. 3. The prompt 1500 in FIG. 15A is a specific example of a code evaluation prompt that the code evaluation agent 130 generates to transmit to the code evaluation LLM. The prompt 1500 in FIG. 15A includes information items (texts) such as a natural language 1501 of a code evaluation instruction, a review criterion 1502, a review procedure 1503, a response form 1504 of the review result, a score (evaluation point) 1505, a total score 1506, and progress 1507 from the previous time.

Natural language 1501 is, for example, “You are a skilled software engineer with deep knowledge about {INPUT_LANG} and {OUTPUT_LANG}. Review and evaluate the {OUTPUT_LANG} code submitted by converter_agent.” The converter_agent corresponds to the code conversion agent 110 (the code generation LLM 150 actually converts and generates the code).

Each evaluation item is described in the review criterion 1502. A description example of the review criterion 1502 is as follows.
1. Equivalence of functions: whether same function as the original {INPUT_LANG} code is realized (1 to 10 points)
2. Convention of {OUTPUT_LANG}: whether general expression of {OUTPUT_LANG} is followed (1 to 10 points)
3. Efficiency: whether unnecessarily complex or inefficient implementation exists (1 to 10 points)
4. Readability: whether the code is clear and easy to understand (1 to 10 points)
5. Error handling: whether appropriate error handling is implemented (1 to 10 points)

In the review procedure 1503, an evaluation procedure is described. A description example of the review procedure 1503 is as follows.
1. Analyze the submitted {OUTPUT_LANG} code in detail.
2. Evaluate each criterion with 1 to 10 points to calculate the total score.
3. Specifically point out the points that need to be improved and present improvement proposals.
4. Evaluate the progress from the previous review and check whether the progress is stagnant.
5. Make a determination.

In the response form 1504 of the review result, specification of a format when the review result is returned from the LLM for code evaluation to the code evaluation agent 130 is described. In the score (evaluation point) 1505, a parameter of the score of each evaluation item is described. In the total score 1506, parameters of the total score/comprehensive evaluation point are described. In the progress 1507 from the previous time, a detailed description regarding the progress from the previous evaluation is described as necessary.

FIG. 15B is a continuation of the prompt 1500 in FIG. 15A. The prompt 1500 includes an improvement point 1508, an improvement proposal 1509, a determination 1510, a determination criterion 1511, and a note 1512.

In the improvement point 1508, parameters of the improvement point are described. The improvement proposal 1509 describes parameters of the improvement proposal. In the determination 1510, parameters for determination (in other words, evaluation result determination/comprehensive evaluation) are described. In the determination criterion 1511, a determination criterion for determining an evaluation result is described.

A description example of the determination criterion 1511 is as follows.
{TERMINATION_KEYWORD}: Total score is 45 points or more, and 7 points or more in all items
NEEDS_IMPROVEMENT: When the completion criterion is not satisfied, but there is progress from the previous time
STAGNATED: When the same problem is pointed out three times in a row and progress is not seen

The note 1512 describes notes for the code evaluation. A description example of the note 1512 is as follows.
**(Most important) To prevent confusion of converter_agent, be careful not to keep the same score for {SAME_SCORE_THRESHOLD} times or more in a row.**
In each review, evaluate changes from previous time especially carefully.
When a stagnation condition (determination is STAGNATED) is detected, suggest a new approach to converter_agent.
Strictly apply the criteria for determining completion (determination is {TERMINATION_KEYWORD}).
Do not write code in any case. Perform evaluation and determination only.

### UI Screen Example

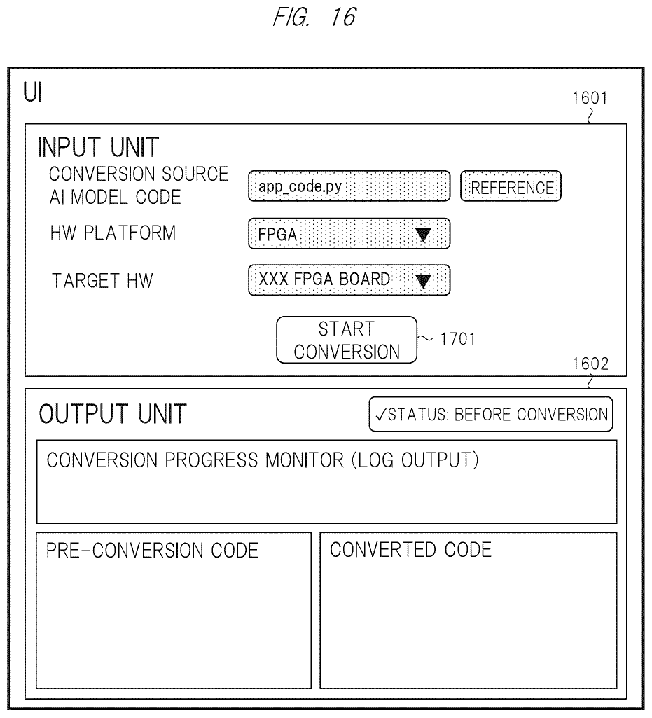

FIG. 16 illustrates a display example of a screen with a graphical user interface (GUI) as an example of a user interface (UI) provided by the language conversion system 1 to the user. The screen of FIG. 16 includes an input unit 1601 and an output unit 1602. The input unit 1601 includes, as items, a conversion source AI model code, an HW platform, a target HW, a conversion start button 1701, and the like. The conversion source AI model code item is an item that designates input of the scripting language operation-level code 101 before conversion. For example, the file of the code can be designated by the item. The HW platform item is an item for designating a hardware platform (FPGA/ASIC or the like) of the conversion destination. The target HW item is an item for designating target hardware (for example, an FPGA board) of the conversion destination. After the user specifies necessary input information on the input unit 1601, the conversion processing by the language conversion system 1 can be started by operating the conversion start button 1701.

The output unit 1602 includes, as items, a status, a conversion progress monitor (log output), a pre-conversion code, and a converted code. In the status item, a current status such as before start of conversion, during conversion processing, or after completion of conversion is displayed. Information such as a log indicating the conversion progress is displayed in the conversion progress monitor (log output) item. In the pre-conversion code item, the scripting language operation-level code 101 before conversion is displayed. In the converted code item, the compiler language operation-level code 103 obtained after the conversion is displayed.

In the conversion progress monitor (log output) item, the code evaluation information by the code evaluation agent 130 and the code modification information by the code modification agent 120 may be displayed, or a code evaluation field, a code modification field, or the like may be separately provided.

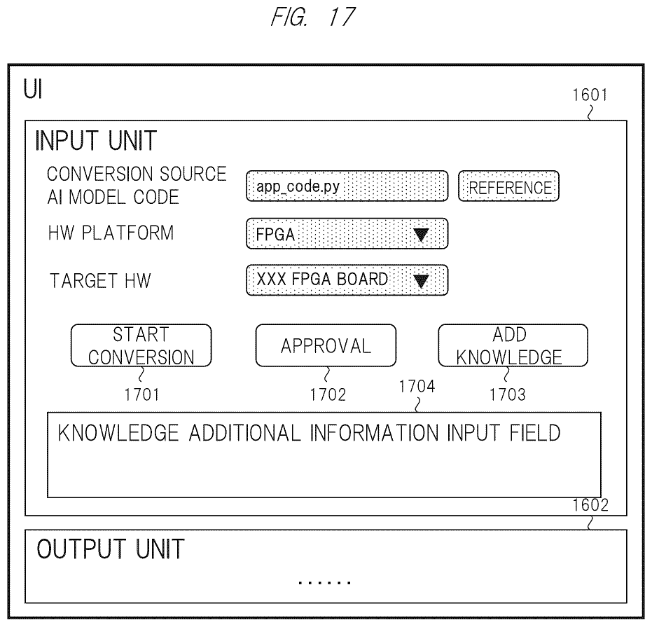

FIG. 17 illustrates another screen example. FIG. 17 is another display example related to the input unit 1601 of FIG. 16. As a difference, the input unit 1601 includes a conversion start button 1701, an approval button 1702, a knowledge addition button 1703, and a knowledge additional information input field 1704.

The knowledge addition button 1703 is operated when the high-level synthesis supplemental information 102 is additionally input. The user appropriately inputs the high-level synthesis supplemental information 102 (in other words, knowledge information) to be additionally input into the knowledge additional information input field 1704, and operates the knowledge addition button 1703. The input may be a direct text input or a reference from an existing knowledge information file.

The approval button 1702 is operated when the user checks and confirms, for each cycle, the high-level synthesis C++ operation-level code, that is the converted code generated by the code generation LLM 150, determines whether to approve it, and operates the button when approving it. When approved, this results in an output as compiler language operation-level code 103. Note that an approval button 1702 may be displayed near the converted code item of the output unit 1602.

Furthermore, in a case where the user cannot approve the converted code, the user may additionally input knowledge information into the knowledge additional information input field 1704 and operate the knowledge addition button 1703. After pressing the knowledge addition button 1703, the user presses the conversion start button 1701. As a result, it is possible to shift to the next code generation cycle in a state where the knowledge information is reflected.

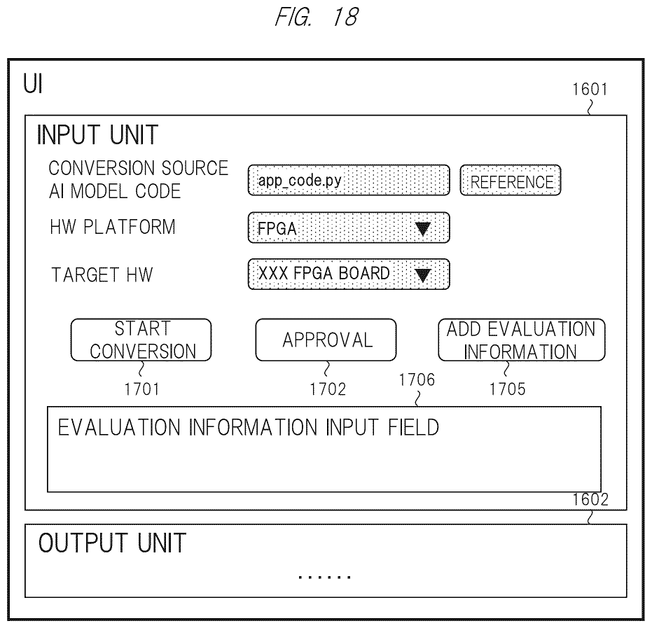

FIG. 18 illustrates another screen example. FIG. 18 is another display example related to the input unit 1601 of FIG. 16. As a difference, the input unit 1601 includes a conversion start button 1701, an approval button 1702, an evaluation information addition button 1705, and an evaluation information input field 1706. Note that, in addition to the function/GUI related to the knowledge addition of FIG. 17, a function/GUI of the evaluation information input of FIG. 18 may be provided. In addition, the output unit 1602 may be provided with the evaluation information addition button 1705 and the evaluation information input field 1706.

In the modification corresponding to FIG. 18, the code evaluation itself for the converted code is not performed by the computer/LLM, but is performed by the user. In other words, in the modification, instead of the function of the code evaluation agent 130 of FIG. 3, a function such as a GUI that supports the work of code evaluation by the user is provided. The system may be regarded as including a code evaluation GUI processing unit instead of the code evaluation agent 130.

A flow in a case where code evaluation by the user is performed on the converted code generated by the computer (code conversion agent 110 and code generation LLM 150) and code modification is performed by the computer (code modification agent 120) is as follows.

In the converted code field of the output unit 1602 of the screen of FIG. 18, the user looks at the intermediate code 104 provisionally generated by the code generation LLM 150 and evaluates the code. In a case where the user cannot approve the intermediate code 104 as a result of the evaluation, the user inputs his/her evaluation result in the evaluation information input field 1706, and then operates the evaluation information addition button 1705 and operates the conversion start button 1701. As a result, in the next cycle, the converted code modified by the code modification agent 120 and the code generation LLM 150 is generated by reflecting the evaluation result of the user. The user can check the converted code on the screen and repeat the cycle as well. In a case where the user approves the converted code, the user can press the approval button 1702 to output the converted code as the compiler language operation-level code 103.

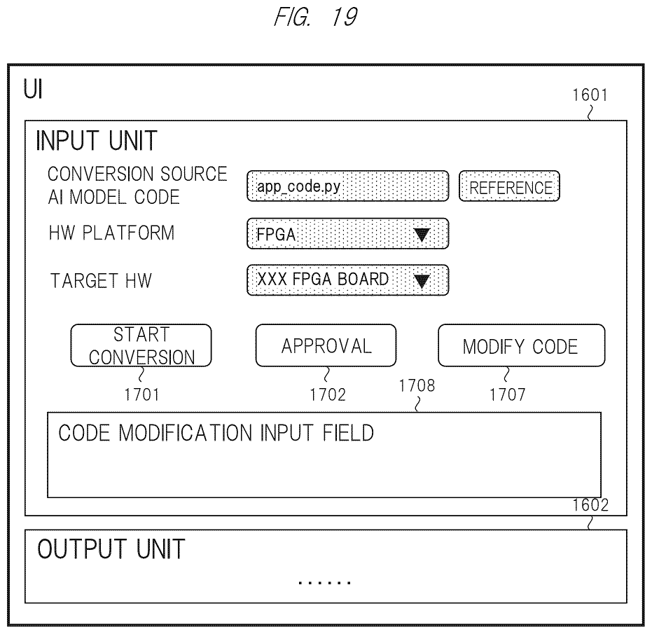

FIG. 19 illustrates another screen example. FIG. 19 is another display example related to the input unit 1601 of FIG. 16. As a difference, the input unit 1601 includes a conversion start button 1701, an approval button 1702, a code modification button 1707, and a code modification input field 1708. Note that in addition to the function/GUI related to the knowledge addition of FIG. 17 and the function/GUI related to the evaluation input of FIG. 18, a function/GUI of the evaluation information input of FIG. 19 may be provided. In addition, the output unit 1602 may be provided with the code modification button 1707 and the code modification input field 1708. Note that the user can also modify the original program code on a separate screen, and refer to and designate the modified program code in the conversion source AI model code item.

In the modification corresponding to FIG. 19, the code modification itself for the converted code is not performed by the computer/LLM, but is performed by the user. In other words, in the modification, instead of the function of the code modification agent 120 of FIG. 3, a function such as a GUI that supports the work of code modification by the user is provided. The present system may be regarded as including a code modification GUI processing unit instead of the code modification agent 120.

A flow in a case where code evaluation is performed by the computer (code evaluation agent 130) on the converted code generated by the computer (code conversion agent 110 and code generation LLM 150) and code modification is performed by the user is as follows.

On the output unit 1602 of the screen of FIG. 19, the user checks the intermediate code 104 provisionally generated by the code generation LLM 150 and the code evaluation result by the code evaluation agent 130. As a result of the evaluation, in a case where the user cannot approve the intermediate code 104, the user inputs a code modification portion by the user into the code modification input field 1708, and then operates the code modification button 1707 and operates the conversion start button 1701. As a result, in the next cycle, the code evaluation by the code evaluation agent 130 is performed by reflecting the code modification portion by the user, and the evaluation result is output to the screen. The user can confirm the evaluation result of the converted code (modified code) on the screen and repeat the cycle similarly. In a case where the user approves the converted code, the user can press the approval button 1702 to output the converted code as the compiler language operation-level code 103.

The function of the code evaluation and work support GUI by the user in FIG. 18 and the function of the code modification and work support GUI by the user in FIG. 19 can be combined. That is, in this form, the code generation LLM 150 performs code conversion, and a cycle in which the user evaluates and modifies the converted code (intermediate code 104) is repeated as necessary, and the converted code is approved by the user and output.

### Computer System

FIG. 20 illustrates a configuration example of a computer system that is an implementation example of the language conversion device 10 of FIG. 1. The computer system of FIG. 20 mainly includes a computer 2000. In the computer system of FIG. 20, an input device 2005 and an output device 2006 are externally connected to the computer 2000. In addition, the computer 2000 is connected to one or more LLM servers 2020 via a communication network 2009. The communication network 2009 may be the Internet or a LAN. The input device 2005 and the output device 2006 may be built into the computer 2000.

The computer 2000 includes an arithmetic device 2001 including a processor and the like, a storage device 2002 including a memory and the like, a communication interface device 2003, an input/output interface device 2004, and the like, and these components are connected to each other by an architecture such as a bus. The computer 2000 executes processing according to the program read from the memory of the storage device 2002 by the arithmetic device 2001. As a result, various functions/processing units such as the code conversion unit 11 illustrated in FIG. 1 are realized. Various data and information handled by various functions/processing units are stored in the internal storage device 2002 or an externally connected storage device.

In the communication interface device 2003, a communication interface corresponding to the communication network 2009 is implemented. The LLM server 2020 is a server device on which the LLM is implemented. For example, various LLMs such as the code generation LLM 150 in FIG. 3 are implemented in the LLM server 2020. The computer 2000 appropriately communicates with the LLM server 2020. As a result, transmission of a prompt to the LLM (such as a request corresponding thereto), reception of a response from the LLM, and the like are realized.

The input device 2005 and the output device 2006 are connected to the input/output interface device 2004. Examples of the input device 2005 include a keyboard, a mouse, and a microphone. Examples of the output device 2006 include a display, a printer, and a speaker. The input device 2005 and the output device 2006 may be a touch panel or the like. The user U1 performs an operation or the like on the user interface 2010 configured using the input device 2005 and the output device 2006.

Note that, in the configuration example of FIG. 20, the case of the form of client-server or the cloud computing in which the LLM implemented in the LLM server 2020 on the communication network 2009 is used from the local computer 2000 (in other words, the client terminal) is illustrated, but the present disclosure is not limited thereto. In another embodiment, as illustrated in the drawing, a local LLM processing unit 2030 in which an LLM is implemented may be provided inside the local computer 2000. The local LLM processing unit 2030 is a unit that performs processing by the local LLM. The local LLM processing unit 2030 may be implemented by a dedicated AI engine/AI chip (for example, NPU). The processor of the arithmetic device 2001 may implement the above-described function using the LLM by exchanging with the local LLM of the local LLM processing unit 2030.

A program (in other words, the language conversion program and the program of the embodiment) for realizing the function of the language conversion system 1 is stored in, for example, the storage device 2002 or an external storage device. This program is a program for causing a processor of the arithmetic device 2001 to execute processing (processing for realizing the function of the language conversion system 1). This program may be installed in the computer 2000 in advance, or may be downloaded from a server or the like on the communication network 2009. The program may be provided in a form stored in a storage medium such as a disk or a memory card.

In the language conversion device, the method, and the program of the above-described embodiment (particularly, second embodiment), an implementation example of performing inference using a trained model (particularly, LLM) in AI/machine learning has been described. Although the case where the LLM for code conversion (code generation LLM 150) also performs code modification has been described, the present disclosure is not limited thereto, and an LLM for code conversion and an LLM for code modification may be separately provided as a modification.

In the second embodiment, an implementation example using artificial intelligence (LLM) is described on the basis of the configuration of the first embodiment, but the present disclosure is not limited thereto. In a case where the field of the target program/hardware or application/software is limited to some extent, implementation by rule-based software is also possible.

Although the embodiments of the present disclosure have been specifically described above, the present disclosure is not limited to the above-described embodiments, and various modifications can be made without departing from the gist of the present disclosure. In each embodiment, components can be added, deleted, replaced, and the like, except for essential components. When not particularly limited, each component may be singular or plural. A combination of the embodiments and modifications is also possible.

What is claimed is:

1. A language conversion device that converts a scripting language operation-level code related to hardware design into a compiler language operation-level code related to implementation of the hardware,
the language conversion device comprising a processor,
wherein the processor
inputs the scripting language operation-level code and high-level synthesis supplemental information including information related to language extension necessary for high-level synthesis of the compiler language operation-level code, and
converts the input scripting language operation-level code into the compiler language operation-level code based on the high-level synthesis supplemental information.

2. The language conversion device according to claim 1,
wherein the processor performs code evaluation on an intermediate code that is the converted compiler language operation-level code, and outputs the compiler language operation-level code when an evaluation result satisfies a criterion.

3. The language conversion device according to claim 2,
wherein the processor modifies the compiler language operation-level code when the evaluation result does not satisfy the criterion.

4. The language conversion device according to claim 1,
wherein the processor
generates a code conversion prompt describing an instruction for converting the input scripting language operation-level code into the compiler language operation-level code based on the high-level synthesis supplemental information,
transmits the code conversion prompt to a large-scale language model for code conversion, and
obtains the compiler language operation-level code generated by the large-scale language model for code conversion from the large-scale language model for code conversion.

5. The language conversion device according to claim 2,
wherein the processor
generates a code evaluation prompt describing an instruction for performing the code evaluation on the intermediate code,
transmits the code evaluation prompt to a large-scale language model for code evaluation, and
obtains a code evaluation result generated by the large-scale language model for code evaluation from the large-scale language model for code evaluation.

6. The language conversion device according to claim 3,
wherein the processor
generates a code modification prompt describing an instruction for performing modification on the intermediate code;
transmits the code modification prompt to a large-scale language model for code conversion, and
obtains a code modification result generated by the large-scale language model for code conversion from the large-scale language model for code conversion.

7. The language conversion device according to claim 3,
wherein the processor extracts an improvement point for the intermediate code based on an evaluation result of the code evaluation, and modifies the compiler language operation-level code using the extracted improvement point.

8. The language conversion device according to claim 1,
wherein a high-level synthesis supplemental information database in which the high-level synthesis supplemental information is stored is stored in a memory, and
wherein the processor
extracts summary information from the scripting language operation-level code,
searches the high-level synthesis supplemental information database using the extracted summary information, obtains the high-level synthesis supplemental information including information about the necessary language extension as a search result, and
converts the scripting language operation-level code into the compiler language operation-level code using the obtained high-level synthesis supplemental information.

9. The language conversion device according to claim 1,
wherein the high-level synthesis supplemental information includes at least one piece of information among a correct result code set related to a pair of a scripting language operation-level code and a compiler language operation-level code, a scripting language library function for high-level synthesis, instruction information for efficiently using the hardware, implementation know-how information related to implementation of the hardware, and environment information of a high-level synthesis tool.

10. The language conversion device according to claim 2,
wherein the code evaluation includes calculating an evaluation point for each evaluation item in the evaluation items of a plurality of viewpoints with respect to the intermediate code, and comparing the evaluation point with a threshold to determine whether the evaluation result satisfies the criterion.

11. A language conversion method executed by a language conversion device that converts a scripting language operation-level code related to hardware design into a compiler language operation-level code related to implementation of the hardware,
wherein the language conversion device includes a processor,
the language conversion method comprising the steps of:
inputting, by the processor, the scripting language operation-level code and high-level synthesis supplemental information including information related to language extension necessary for high-level synthesis of the compiler language operation-level code; and
converting, by the processor, the input scripting language operation-level code into the compiler language operation-level code based on the high-level synthesis supplemental information.

12. A language conversion program for causing a language conversion device that converts a scripting language operation-level code related to hardware design into a compiler language operation-level code related to implementation of the hardware to execute processing,
wherein the language conversion device includes a processor,
the processing to be executed by the processor comprising:
inputting the scripting language operation-level code and high-level synthesis supplemental information including information related to language extension necessary for high-level synthesis of the compiler language operation-level code; and
converting the input scripting language operation-level code into the compiler language operation-level code based on the high-level synthesis supplemental information.
